(19) United States
(12) Patent Application Publication
(10) Pub. No.: US 2011/0097927 A1
(43) Pub. Date: Apr. 28, 2011

(54) EXTENSION CABLE ANCHORING ARRANGEMENT

(75) Inventor: Meng-Hsiu WU, Taoyuan Hsien (TW)

(73) Assignee: EXITO ELECTRONICS CO., LTD., Taoyuan Hsien (TW)

(21) Appl. No.: 12/605,360

(22) Filed: Oct. 25, 2009

(51) Int. Cl. H01R 11/00

(52) U.S. Cl. 439/505

(57) ABSTRACT

An extension cable anchoring arrangement includes an extension cable that has an electrical plug at its one end and multiple electrical sockets spaced along its length, pointed anchoring members for fastening to the floor at selected locations, and connecting structures each having a first connecting member formed integral with the periphery of one electrical socket and a second connecting member formed integral with the head of one anchoring member remote from the pointed end and connectable to the first connecting member to secure the respective electrical socket to the respective anchoring member.

### BACKGROUND OF THE INVENTION

1. Field of the Invention

The present invention relates to extension cable mounting technology and more particularly, to an extension cable anchoring arrangement, which secures the electrical sockets of the extension cable to the floor, avoiding accidental displacement and assuring a high level of safety in application.

2. Description of the Related Art

Due to the limited number of electric outlets in a room or the limited length of the power cords of electric/electronic devices, people may use an extension cable to extend the reach of electric/electronic devices. However, when an extension cable is used and connected to an electrical outlet on the wall or floor for the connection of multiple electric/electronic devices, the extension cable tends to be stretched or moved accidentally, causing disconnection of the power cords of the electric/electronic devices or a short-circuit accident.

### SUMMARY OF THE INVENTION

The present invention has been accomplished under the circumstances in view. It is one object of the present invention to provide an extension cable anchoring arrangement, which secures the extension cable in place, assuring a high level of safety in application.

To achieve this and other objects of the present invention, an extension cable anchoring arrangement comprises an extension cable having an electrical plug and multiple electrical sockets, anchoring members for fastening to the floor at selected locations, and connecting structures for connecting the anchoring members to the electrical sockets of the extension cable. Each connecting structure comprises a first connecting member formed integral with the periphery of one electrical socket, and a second connecting member formed integral with the head of one anchoring member remote from the pointed end of the anchoring member and connectable to the first connecting member to secure the respective electrical socket to the respective anchoring member. The first connecting member and the second connecting member can be detachably fastened together by means of a pivot member, for example, pivot bolt, and a lock member, for example, wing nut.

### BRIEF DESCRIPTION OF THE DRAWINGS

FIG. 1 is an elevational view of an extension cable anchoring arrangement in accordance with the present invention.

FIG. 2 is an exploded view of a part of the extension cable anchoring arrangement in accordance with the present invention.

FIG. 3 is a schematic sectional applied view of the present invention, showing the anchoring members fastened to the floor.

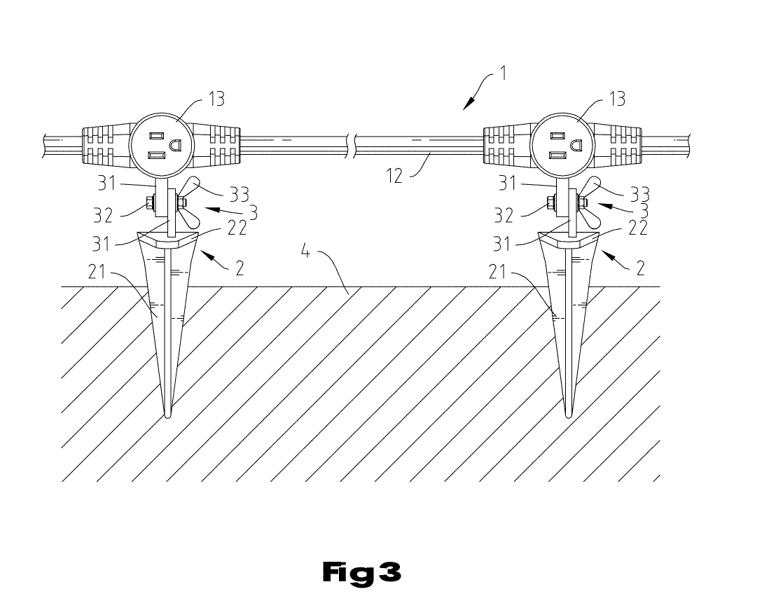

FIG. 4 is an elevational view of a part of the present invention, showing the angular position of one electrical socket adjusted relative to the respective anchoring member.

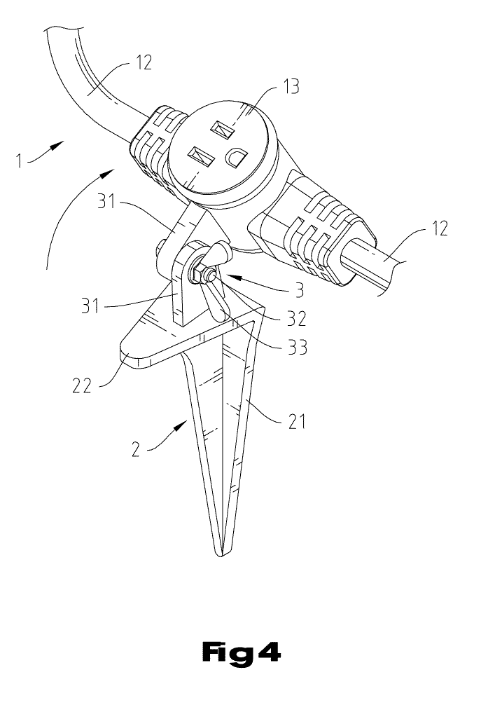

FIG. 5 is an elevational view of the present invention, showing an alternate form of the connecting structure.

FIG. 6 is an exploded view of FIG. 5.

FIG. 7 is an elevational view of the present invention, showing another alternate form of the connecting structure.

FIG. 8 is an exploded view of FIG. 7.

### DETAILED DESCRIPTION OF THE PREFERRED EMBODIMENT

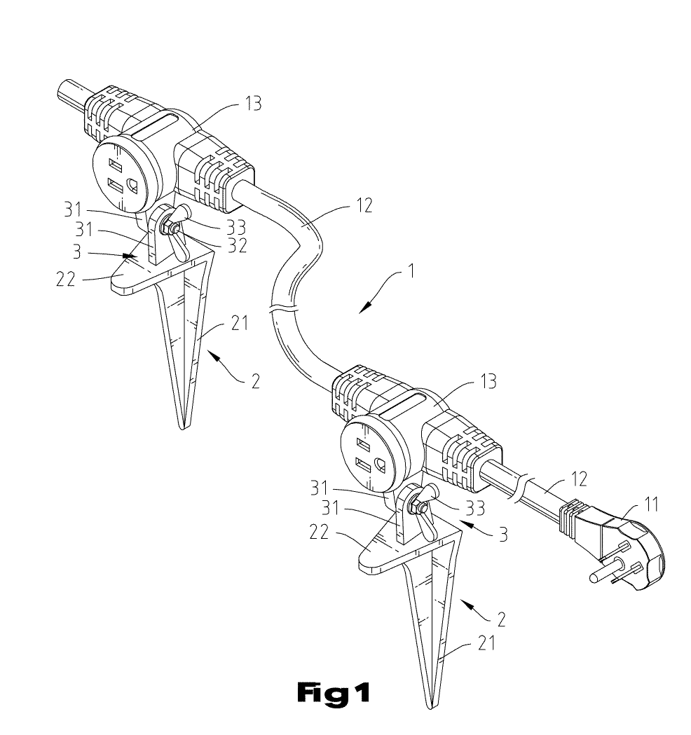

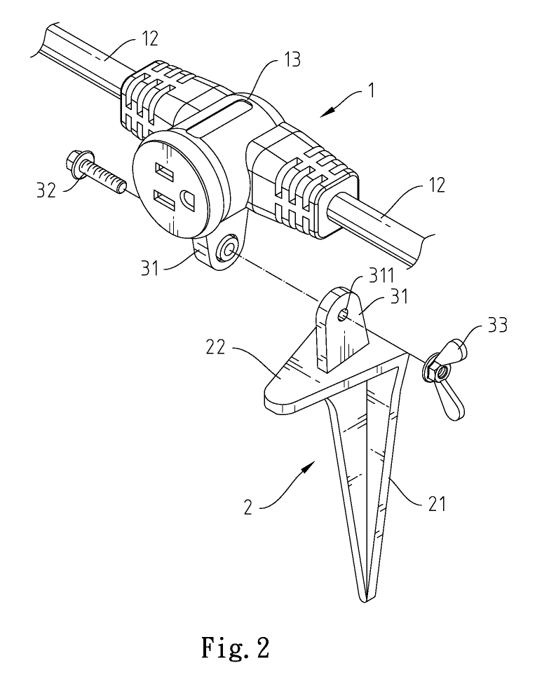

Referring to FIGS. 1 and 2, anchoring members 2 are respectively connected to an extension cable 1 by a respective connecting structure 3 for securing the extension cable 1 in place.

The extension cable 1 comprises a power line 12, an electrical plug 11 electrically connected to one end of the power line 12, and a plurality of electrical sockets 13 electrically mounted in the power line 12 and spaced from one another along the length of the power line 12.

The anchoring member 2 comprises an elongated anchoring body 21 that reduces gradually from one end, namely, the top end toward the other end, namely, the pointed bottom end, head 22 located on the largest top end of the elongated anchoring body 21.

Each connecting structure 3 comprises two connecting plates 31 respectively formed integral with the periphery of one electrical socket 13 of the extension cable 1 and the top wall of the head 22 of one anchoring member 2, each connecting plate 31 having a pivot hole 311, a pivot bolt, for example, pivot bolt 32 for insertion through the mounting through hole 311 on each of the two connecting plates 31, and a lock member, for example, wing nut 33 for threading onto the pivot bolt 32 to lock the two connecting plates 31 together.

During application, attach the connecting plate 31 at each electrical socket 13 to the connecting plate 31 at the head 22 of one anchoring member 2 to keep the respective pivot holes 311 in alignment, and then insert the pivot bolt 32 of each connecting structure 3 through the pivot holes 311 of the two connecting plates 31 of the same connecting structure 3, and then thread the respective wing nut 33 onto the respective pivot bolt 32 to lock the two connecting plates 31 of the same connecting structure 3 together. When loosening the wing nut 33, the respective electrical socket 13 can be biased relative to the respective anchoring member 2 to the desired angle. After adjustment of the respective electrical socket 13 to the desired angle, the respective wing nut 33 is fastened tight to lock the two connecting plates 31 of the same connecting structure 3 together, supporting the respective electrical socket 13 in the desired position.

Referring to FIGS. 1˜4, during application of the extension cable 1, the electrical plug 11 is connected to an electrical outlet (not shown), and then the anchoring bodies 21 of the anchoring members 2 are respectively fastened to the floor 4 at selected locations, and then the wing nuts 33 are respectively loosened for enabling the electrical sockets 13 to be respectively adjusted to the respective desired angles, and then the wing nuts 33 are respectively fastened tight again to lock the two connecting plates 31 of each of the connecting structures 3 together, supporting the respective electrical sockets 13 in the respective desired positions.

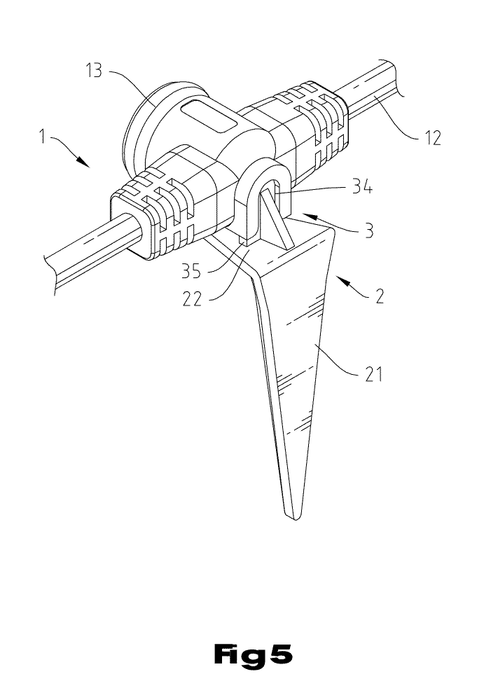

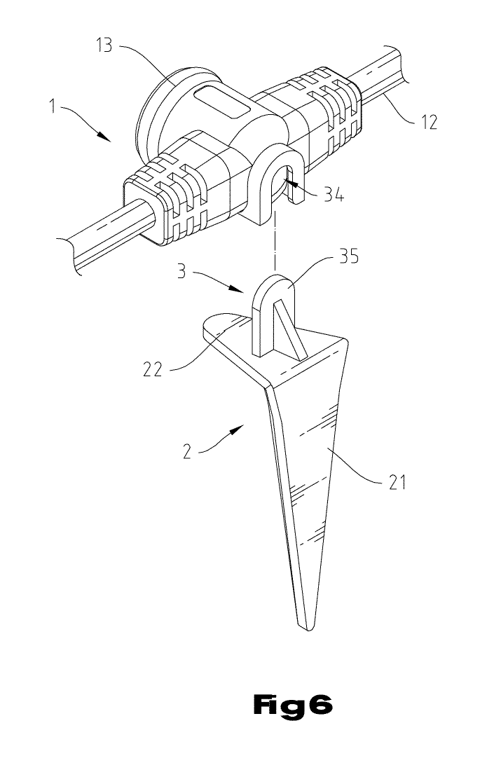

FIGS. 5 and 6 show an alternate form of the connecting structure 3. According to this embodiment, the connecting structure 3 comprises a coupling groove 34 located on the outside wall of the electrical socket 13, and a coupling tongue 35 extended from the head 22 of the respective anchoring member 2 for press-fitting into the coupling groove 34. By means of press-fitting the coupling tongue 35 into the coupling groove 34, the anchoring member 2 is secured to the respective electrical socket 13.

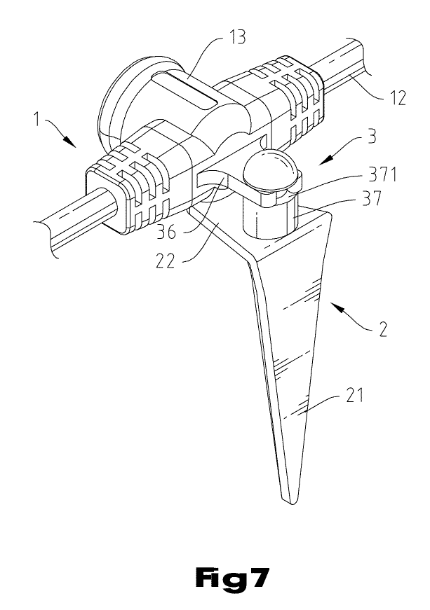

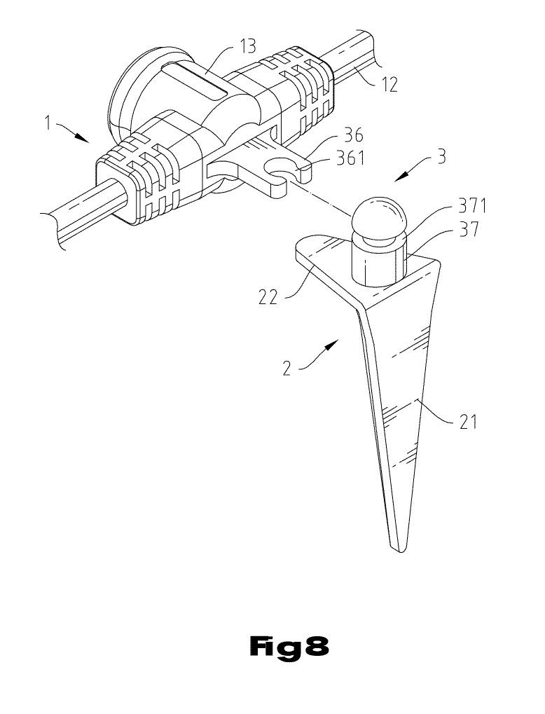

FIGS. 7 and 8 show another alternate form of the connecting structure 3. According to this embodiment, the connecting structure 3 comprises a locating plate 36, and a retaining bolt 37 perpendicularly extended from the head 22 of the respective anchoring member 2 and connectable to the locating plate 36. The locating plate 36 comprises a retaining hole 361. The retaining bolt 37 has a neck 371 that can be transversely forced into engagement with the retaining hole 361 of the locating plate 36. After engagement between the neck 371 of the retaining bolt 37 and the retaining hole 361 of the locating plate 36, the retaining bolt 37 is prohibited from axial displacement relative to the locating plate 36, however, the user can pull the retaining bolt 37 transversely outwardly away from the locating plate 36 with force.

As described above, the invention uses connecting structures 3 to secure anchoring members 2 to the electrical sockets 13 of the extension cable 1 respectively. After connection of the anchoring members 2 to the electrical sockets 13 of the extension cable 1 by the respective connecting structures 3, the anchoring members 2 are fastened to the floor 4, holding the extension cable 1 in place and avoiding accidental displacement of the electrical sockets 13.

A prototype of extension cable anchoring arrangement has been constructed with the features of FIGS. 1˜8. The extension cable anchoring arrangement functions smoothly to provide all of the features disclosed earlier.

What is claimed is:

1. (canceled)

2. (canceled)

3. (canceled)

4. An extension cable anchoring arrangement, comprising:
an extension cable, said extension cable comprising a power line, an electrical plug electrically connected to one end of said power line and a plurality of electrical sockets electrically mounted in said power line and spaced from one another along the length of said power line;
a plurality of anchoring members for fastening to the floor at selected locations, each of said anchoring members comprising an elongated anchoring body having a pointed end, and a head formed integrally with one end of said anchoring body away from said pointed end; and
a plurality of connecting structures for securing said anchoring members to said electrical sockets of said extension cable respectively, each of said connecting structures comprising a first connecting member formed integrally with the periphery of one of said electrical sockets and a second connecting member formed integrally with the head of one of said anchoring members and connectable to said first connecting member;
wherein the first connecting member of each of said connecting structures is a locating plate extending from the periphery of each of said electrical sockets and comprising a retaining hole; the second connecting member of each of said connecting structures is a retaining bolt perpendicularly extending from the head of each of said anchoring members, said each retaining bolt comprises a neck for fastening to the retaining hole of the associated first connecting member.
